(19) United States
(12) Patent Application Publication
(10) Pub. No.: US 2007/0155934 A1
(43) Pub. Date: Jul. 5, 2007

(54) NOVEL POLYOL-POLYAMINE SYNTHESIZED FROM VEGETABLE OILS

(75) Inventors: Thomas Christopher Waidner, Lobeco, SC (US); Victor Martin Granquist, Lobeco, SC (US)

Correspondence Address: DENNIS G. LAPOINTE;LAPOINTE LAW GROUP, PL, PO BOX 1294, TARPON SPRINGS, FL, 34688-1294, US

(73) Assignee: ARR-MAZ CUSTOM CHEMICALS, INC., Mulberry, FL (US)

(21) Appl. No.: 11/612,699

(22) Filed: Dec. 19, 2006

Related U.S. Application Data
(60) Provisional application No. 60/756,123, filed on Jan. 4, 2006.

(51) Int. Cl. C08G 18/00

(52) U.S. Cl. 528/44; 528/310

(57) ABSTRACT

A novel material with polyol and polyamine functionality derived from vegetable oils is described. This novel “polyolamine” may be cross-linked with multifunctional cross-linkers to form polymeric materials. This novel material is therefore useful for coatings, adhesives, foams, fibers, sealants and elastomers or other applications where urethanes and polyureas find utility.

### RELATED APPLICATION

This application claims the benefit of U.S. Provisional Application Ser. No. 60/756,123 filed Jan. 4, 2006.

### FIELD OF THE INVENTION

This invention relates to the synthesis of a novel material for use in coatings, adhesives, foams, fibers, sealants and elastomers.

### BACKGROUND OF THE INVENTION

Materials with polyol functionality have been cross-linked with various isocyanates to form various urethane polymers used is numerous applications including but not limited to coatings, adhesives, foams, fibers, sealants and elastomers. In addition, materials that contain amino and/or hydroxyl poly functionality can be cross-linked with isocyanates, anhydrides or other functionalized materials capable of reacting with polyols and/or polyamines to form polymers. Depending upon the ratio of substrate to cross-linker, the physical properties of the polymer will vary.

With the recent price increases on petroleum-derived materials, many polyol substrates for polymer synthesis have experienced significant increases in cost. Vegetable oil derived materials that were once considered too expensive are finding routes into the market as they become more cost competitive. The vegetable oil based polyols/polyamines or “polyolamines” may be suitable replacements for many of their petroleum based analogs for many polyols.

### SUMMARY OF THE INVENTION

As further discussed in detail hereinafter, a novel polyolamine has been discovered that may be cross-linked to form novel urethane-like polymeric materials that have applications for coatings, adhesives, foams, fibers, sealants and elastomers.

### BRIEF DESCRIPTION OF THE DRAWING

In the accompanying drawing,

FIG. 1 depicts a representative example of a reaction process as further discussed hereinafter.

### DETAILED DESCRIPTION OF THE INVENTION

As noted above, a novel polyolamine has been discovered that may be cross-linked to form novel urethane-like polymeric materials that have applications for coatings, adhesives, foams, fibers, sealants and elastomers.

The process involves two steps:

1. The reaction of an expoxidized vegetable oil with an amine to form an intermediate with polyolamine functionality. Examples of suitable expoxidized oils are those derived from soybean, linseed, rapeseed, corn, or any other unsaturated oil that can be expoxidized. Examples of the amine are ethylene diamine, diethylene triamine, triethylene tetramine, tetraethylene pentamine, ammonia, various polyamines, ether amines, and other similar materials known to those skilled in the art.

The amine could also be ethanolamine and other similar amines. Liberated glycerin formed in the amidation step may need to be removed from the polyolamine depending on the application.

2. The second step is the reaction between the polyolamine with a cross linker such as TDI (toluene diisocyanate), MDI (4-4′ methylene-bis (phenylisocyanate), pMDI (polymeric MDI), isophorone diisocyanate, and other cross linking agents as may be known to those skilled in the art, including epoxides and anhydrides.

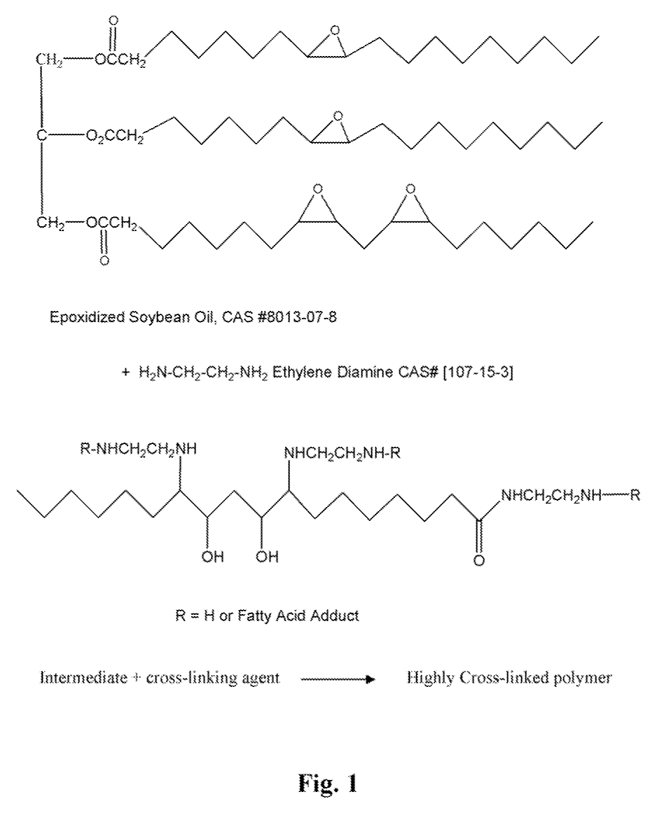

The exact structure of the starting materials, the intermediate and the final polymer will depend on the type of vegetable oil, the degree of epoxidation, the amount and type of amine, the amount and type of cross linker, and the reaction conditions, but an example is set in FIG. 1.

It must be emphasized that the structure for the epoxidized vegetable oil and for the intermediate product (and of course for the end polymer) will be highly variable and of course a mixture. The structure is only a representation based on one isomer in the starting raw materials.

### EXAMPLES

### Example 1

### Preparation of Epoxidized Soybean Oil Adduct with Ethylenediamine (ESO-EDA):

Into a 1000-mL, 4 necked round bottom flask equipped with agitation, temperature (RTD) controller, nitrogen flow and heating mantle, charge 171 parts of 1,2-ethylenediamine (EDA). The EDA is heated in a nitrogen atmosphere to 95° C. Once the EDA reaches 95° C., 476 parts of Epoxidized Soybean Oil (ESO) is charged over several hours while the temperature is allowed to rise from 95 to 135° C. The reaction is then heated in an inert atmosphere to 135-140° C. and held for three hours. Vacuum is applied to evacuate the vessel to 25-mm pressure and the excess EDA is distilled from the reaction. The reaction is then heated under vacuum to 205° C. and liberated glycerin is removed by distillation. The resulting product (ESO-EDA) is cooled to approximately 75° C. and transferred to storage.

### Example 2

### Preparation of Epoxidized Soybean Oil Adduct with 1,6-Hexanediamine (ESO-HDA):

Into a 1000-mL, 4 necked round bottom flask equipped with agitation, temperature (RTD) controller, nitrogen flow and heating mantle, charge 82.3 parts of 1,6-hexanediamine (HDA). The HDA is heated in a nitrogen atmosphere to 115° C. Once the HDA reaches 95° C., 119 parts of Epoxidized Soybean Oil (ESO) is charged over several hours while the temperature is allowed to rise from 95 to 135° C. The reaction is then heated in an inert atmosphere to 135-140° C. and held for three hours. Vacuum is applied to evacuate the vessel to 25-mm pressure and the excess HDA is distilled from the reaction. The reaction is then heated under vacuum to 205° C. and the liberated glycerin is removed by distillation. The resulting product (ESO-HDA) is cooled to approximately 75° C. and transferred to storage.

### Example 3

### Preparation of Epoxidized Linseed Oil Adduct with 1,2-Ethylenediamine (ELO-EDA):

Into a 1000-mL, 4 necked round bottom flask equipped with agitation, temperature (RTD) controller, nitrogen flow and heating mantle, charge 84.2 parts of 1,2-ethylenediamine (EDA). The EDA is heated in a nitrogen atmosphere to 115° C. Once the EDA reaches 95° C., 195.4 parts of Epoxidized Linseed Oil (ELO) is charged over several hours while the temperature is allowed to rise from 95 to 140° C. The reaction is then heated in an inert atmosphere to 135-140° C. and held for three hours. Vacuum is applied to evacuate the vessel to 25-mm pressure and the excess EDA is distilled from the reaction. The reaction is then heated under vacuum to 205° C. and the liberated glycerin is removed by distillation. The resulting product (ELO-EDA) is cooled to approximately 75° C. and transferred to storage.

### Example 4

### Preparation of the Polymer Resin from ESO-EDA and pMDI:

Into a 250-mL 3 necked round bottom flask equipped with agitation charge 10.6 grams of ESO-EDA and 150 g of N-methylpyrrolidinone. Agitate to dissolve and heat to 60-70° C. Into a beaker, charge 8.5 g of pMDI into 62 g N-methylpyrrolidinone and dissolve. With agitation, charge the pMDI solution of the ESO-EDA solution rapidly. A precipitate is immediately observed and a thick crystalline-like material forms. The product is held at 70-75° C. for 2 hours then filtered. The polymer is washed by slurrying it into 400-mL of N-methylpyrrolidinone, soaked for 15 minutes and filtered. The N-methylpyrrolidinone wash is repeated. The polymer is subsequently washed by slurrying it into 400-mL of methanol, soaked for 15 minutes and filtered. The polymer is then slurried into a second 400-mL portion of methanol, heated to reflux for 5 hours then filtered at 60-65° C. The polymer is dried for 48 hours at 90° C. The polymer is characterized by differential scanning calorimetry (DSC) and Fourier Transform Infrared spectroscopy (FTIR). The DSC is characterized by transitions at ca. 130° C. and 215° C. with a polymer melt temperature of ca. 365° C. The FTIR shows carbonyl peaks characteristic of polyurethane and polyurer functionality at 1650-1690 cm⁻¹.

### Example 5

### Preparation of a Polymer Foam

Into a 400-mL beaker charge 10.0 g of ESO-EDA and dissolve in 90-mL chloroform. Heat the solution to 60° C. In a separate beaker dissolve 8.0 g pMDI into 10-mL chloroform. While agitating the ESO-EDA solution, rapidly charge the pMDI solution into the ESO-EDA. An off white precipitate is observed. The material forms a foam that immediately floats to the surface of the chloroform. Agitate the mixture at 60° C. for 1 hour. Decant the chloroform and add 200-mL of fresh chloroform. Heat to 60° C. and hold for an additional hour. Decant the chloroform and dry the foam in an oven at 90° C. for 16 hours. The foam has an approximate density of 0.3 g/cm³. DSC and FTIR results are consistent with the polymer prepared in Example 4.

### Example 6

### Preparation of the Polymer Coating from ESO-EDA and pMDI.

Approximately 350 g of ESO-EDA was charged with 0.2% 1,4-Diazabicyclo[2.2.2]-octane (DABCO) as a cross-linking catalyst. Approximately 25 kg of granulated potassium nitrate (KNO₃) was coated with the 350 g of ESO-EDA/DABCO followed by 250 g pMDI. The KNO₃ was then tumbled for 15 at 50-60° C. then allowed to cure overnight at that temperature. A 10 g sample of the coated KNO3 was then charged to 90 grams of water in a jar and inverted three times. The conductivity was measured over several days. A 10 gram sample of uncoated potassium nitrate was also added into 90 g water as a control. The uncoated KNO3 dissolves in about 10 minutes and has a resulting conductivity of 90 mS/cm. The sample treated with the polymer coating requires 15 days immersed in water to reach 90 mS/cm. The polymer coating is therefore a highly effective moisture barrier.

### Example 7

### Preparation of an Adhesive

Approximately 0.1 g of ESO-EDA was placed on one end of a microscope slide. A second slide was wiped across the first to distribute the ESO-EDA between the two slides over a surface area of ca. 10 cm². The two slides were separated and approximately 0.08 g of pMDI was added to one slide and the two slides were pressed together to cure the adhesive. The adhesive was cured overnight at 90° C. The break force was evaluated using a Chatillon force gauge and the force required to break the slides apart exceeded the 100 lb limit of the gauge.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not means to limit the scope of the invention. Rather, the scope of the invention is to be determined only by the appended claims and their equivalents.

What is claimed is:

1. A novel vegetable oil derived polyolamine material, wherein said vegetable oil derived polyolamine material comprising both a hydroxyl and an amino functionality.

2. The material according to claim 1, wherein said material has a polyol and polyamine functionality and is made by
reacting an expoxidized vegetable oil with an amine component to form an intermediate with a polyolamine functionality.

3. The material according to claim 2, further comprising reacting said material with a cross-linking agent to form a polymeric material useful for coatings, adhesives, foams, fibers, sealants and elastomers.

4. The material according to claim 2, wherein the expoxidized vegetable oil is derived from an unsaturated vegetable oil that can be epoxidized.

5. The material according to claim 2, wherein the expoxidized vegetable oil comprises soybean, linseed, rapeseed, corn, or combinations thereof.

6. The material according to claim 2, wherein the epoxidized vegetable oil is reacted with said amine component to produce a fatty acid derivative comprising a fatty amide, hydroxyl and amino functionality.

7. The material according to claim 2, wherein the amine component comprises ethylenediamine, diethanolamine, hexamethylenediamine, diethylene triamine, triethylene tetramine, tetraethylene pentamine, ammonia, polyamines, ether amines, ethanolamines and combinations thereof.

8. The material according to claim 3, wherein the functionalized cross-linking agent readily reacts with a hydorxyl or amino functionality.

9. The material according to claim 3, wherein the functionalized cross-linking agent is an anhydride, epoxide or isocyanante.

10. The material according to claim 3, wherein the functionalized cross-linking agent comprises a diisocyanate or polyisocyanate.

11. The material according to claim 3, wherein the functionalized cross-linking agent comprises TDI (toluene diisocyanate), MDI (4-4′ methylene-bis (phenylisocyanate)), pMDI (polymeric MDI), isophorone diisocyanate, or combinations thereof.
